(19) United States
(12) Patent Application Publication
(10) Pub. No.: US 2010/0064569 A1
(43) Pub. Date: Mar. 18, 2010

(54) Base for Providing Motion to Decoys

(76) Inventor: Richard A. Wyant, Red Hook, NY (US)

Correspondence Address: LAW OFFICES OF MICHAEL L. WISE, LLC, 260 WALSH RD., LAGRANGEVILLE, NY, 12540, US

(21) Appl. No.: 12/209,404

(22) Filed: Sep. 12, 2008

(51) Int. Cl. A01M 31/06

(52) U.S. Cl. 43/2

(57) ABSTRACT

A base for providing motion to a decoy comprises a lower base portion, an upper base portion, and an elastic member. The upper base portion is pivotally attached to the lower base portion such that the upper base portion can pivot in relation to the lower base portion. The elastic member spans between the lower and upper base portions and is configured to elastically bias the upper base portion to pivot in a given direction in relation to the lower base portion.

### FIELD OF THE INVENTION

The present invention relates generally to decoys, and, more particularly, to bases capable of providing motion to decoys such as those used for hunting.

### BACKGROUND OF THE INVENTION

Decoys have been utilized by hunters for centuries to attract game animals to a position where the animals can be trapped or killed. For example, the use of decoys in the hunting of wild turkey and ducks is commonplace and such decoys are readily available from several decoy manufacturers.

Most conventional decoys are mounted on stakes and are static, meaning that they are not capable of movement after being positioned by the hunter. Nevertheless, despite their widespread use, such static decoys may not be optimal for luring many types of game animals. The effectiveness of given decoy is, in large part, based on how realistic the decoy looks to a living game animal and to what extent the decoy motivates that living game animal to approach the decoy. A game animal, for example, may be naturally motivated to approach a decoy that it perceives as feeding, breeding, or encroaching on its territory. For this reason, some more advanced decoys feature “moveable” bodies, allowing the hunter to choose from among several decoy postures when positioning the decoy. Some postures may, for instance, replicate feeding while other postures may replicate breeding. What is more, even more advanced decoys actually have the ability to be set into motion after being placed in a given location. For example, U.S. Pat. No. 5,231,780, entitled “Animated Game Bird Decoy,” describes a game bird decoy that appears to flap its wings and rotate its head in response to the pulling of a cord attached to the decoy. Likewise, U.S. patent application Ser. No. 11/683,349, entitled “Decoy and Method of Using Same” and having common inventorship herewith, describes a cord-actuated turkey decoy having a novel mechanism that acts to tilt the decoy forward and backward.

Surprisingly, one particular decoy movement that has recently been found to be quite effective in luring certain types of game animals to the decoy is a repetitive pivoting motion, wherein the decoy is made to rotate back and forth by less than about 90 degrees about a vertical axis while remaining in place. For example, the inventor has determined after several years of personally experimenting with various decoy movements in the field that providing such a pivoting motion to a decoy fashioned to replicate a juvenile male turkey (i.e., Jake) is very successful in drawing adult male turkeys (i.e., Toms) to that decoy. Nevertheless, existing static decoys provide no motion at all, and those that may be actuated by cords do not typically provide this kind of repetitive pivoting motion. As a result, there is a need for base that may be readily used with existing static and cord-actuated decoys to impart a repetitive pivoting motion to those decoys.

### SUMMARY OF THE INVENTION

Embodiments of the present invention address the above-identified need by providing a base capable of providing a repetitive pivoting motion to already existing static and cord-actuated decoys.

In accordance with an aspect of the invention, a base for providing motion to a decoy comprises a lower base portion, an upper base portion, and an elastic member. The upper base portion is pivotally attached to the lower base portion such that the upper base portion can pivot in relation to the lower base portion. The elastic member spans between the lower and upper base portions and is configured to elastically bias the upper base portion to pivot in a given direction in relation to the lower base portion.

In accordance with another aspect of the invention, a base for providing motion to a decoy is formed by receiving a lower base portion, attaching an upper base portion to the lower base portion, and spanning an elastic member between the lower and upper base portions. The upper base portion is attached to the lower base portion such that the upper base portion can pivot in relation to the lower base portion. The elastic member is configured to elastically bias the upper base portion to pivot in a given direction in relation to the lower base portion.

In accordance with one of the above-identified embodiments of the invention, a base for use in providing movement to a decoy comprises a lower base portion and an upper base portion. The upper base portion is pivotally attached to the lower base portion such that the upper base portion can pivot in relation to the lower base portion. An elastic member spans between the lower base and upper base portions and is configured to elastically bias the upper base portion to pivot in a given direction in relation to the lower base portion. The upper base portion comprises two manually separable subportions. Advantageously, these subportions allow the base to accommodate at least two very different types of decoys, namely those that are stake-mounted and static, and those that are cord-actuated and have an integral platform. Actuating the base by a cord attached to the base or attached to a mounted decoy causes the base to provide a pivoting motion to the decoy. A repetitive pivoting motion has been shown to be very effective at luring certain types of game animals (e.g., wild turkeys) to a decoy.

These and other features and advantages of the present invention will become apparent from the following detailed description which is to be read in conjunction with the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a base in accordance with an illustrative embodiment of the invention in combination with a conventional, stake-mounted, static decoy;

FIG. 2 shows a perspective view of the FIG. 1 base with the mounting rod removed;

FIG. 3 shows another perspective view of the FIG. 1 base;

FIG. 4 shows a side-view of the FIG. 1 base;

FIG. 5 shows a plan view of the FIG. 1 base;

FIG. 6 shows a bottom-up view of the FIG. 1 base;

FIG. 7 shows a perspective view of the FIG. 1 base with the second upper subportion removed;

FIG. 8 shows a perspective view of the FIG. 1 lower base portion;

FIG. 9 shows a perspective view of the FIG. 1 upper base portion positioned bottom-up with the second upper subportion removed;

FIG. 10 shows a perspective view of the FIG. 1 base in combination with a cord-actuated decoy with integral platform;

FIG. 11 shows a perspective view of the FIG. 10 combination with the cord drawn so as to actuate the decoy and pivot the base; and

FIG. 12 shows a perspective view of an alternative base in accordance with an additional illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

FIG. 1 shows a perspective view of a base 100 in accordance with a first illustrative embodiment of the invention. Advantageously, the base may be configured for use with two very different types of decoys, namely, conventional, stake-mounted, static decoys as wells as cord-actuated decoys that have their own integral platforms. FIG. 1 shows the base with a conventional, stake-mounted, static decoy 200. At its most elementary level, the illustrative base can be broken down in five basic elements. The base comprises an upper base portion 102 that is pivotally attached to a lower base portion 104 such that the upper base portion can pivot in relation to the lower base portion. An elastic member 106 spans between the upper and lower base portions. A mounting rod 108 is attached to the upper base portion. Finally, a cord 110 is also attached to the upper base portion.

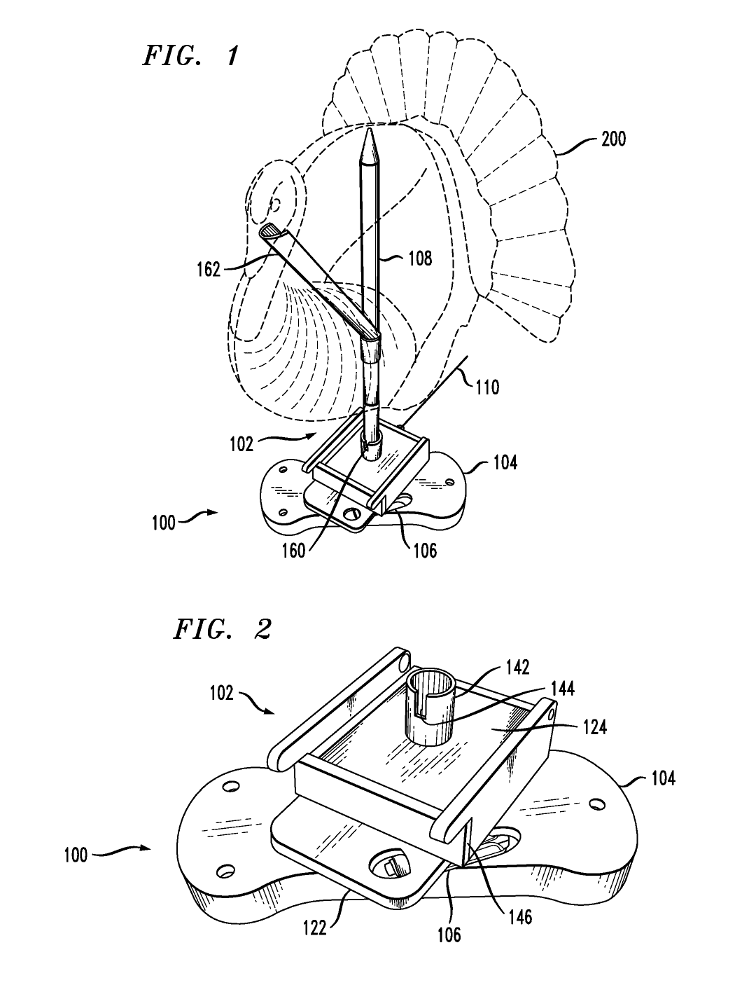

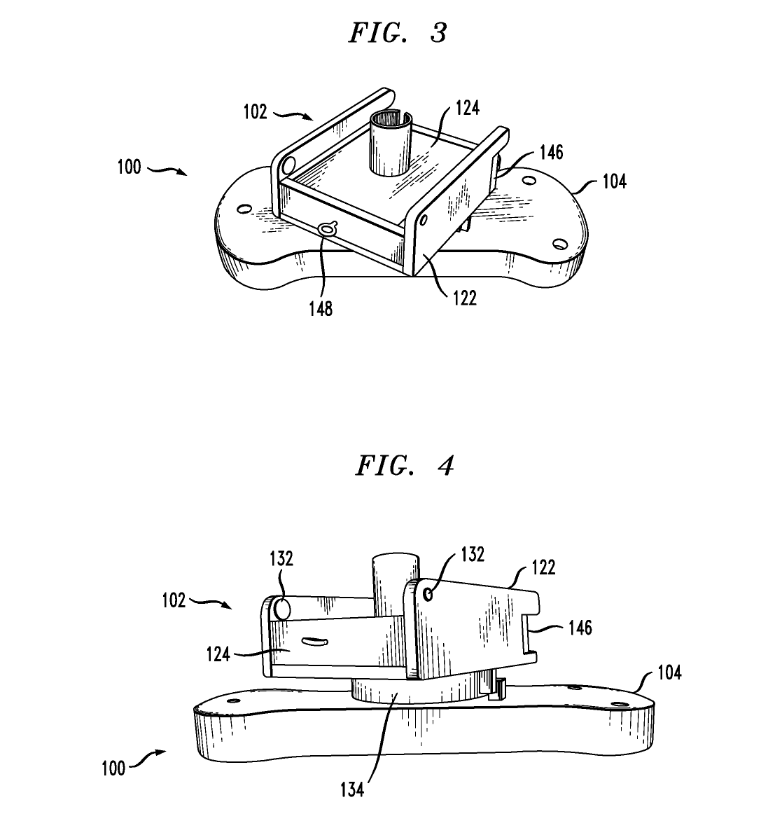

Additional views of the illustrative base, both fully assembled and partially disassembled, are shown in FIGS. 2-9. These additional figures help to provide additional details of the base's constituent elements and the manner in which base functions. The lower base portion comprises a lower cylindrical feature 112 as well as a plurality of anchoring holes 114. The lower base portion also comprises a lower stop feature 116. The underside of the lower base portion comprises some attachment points 118 (i.e., various tabs) that may serve to secure a plurality of anchoring spikes 120.

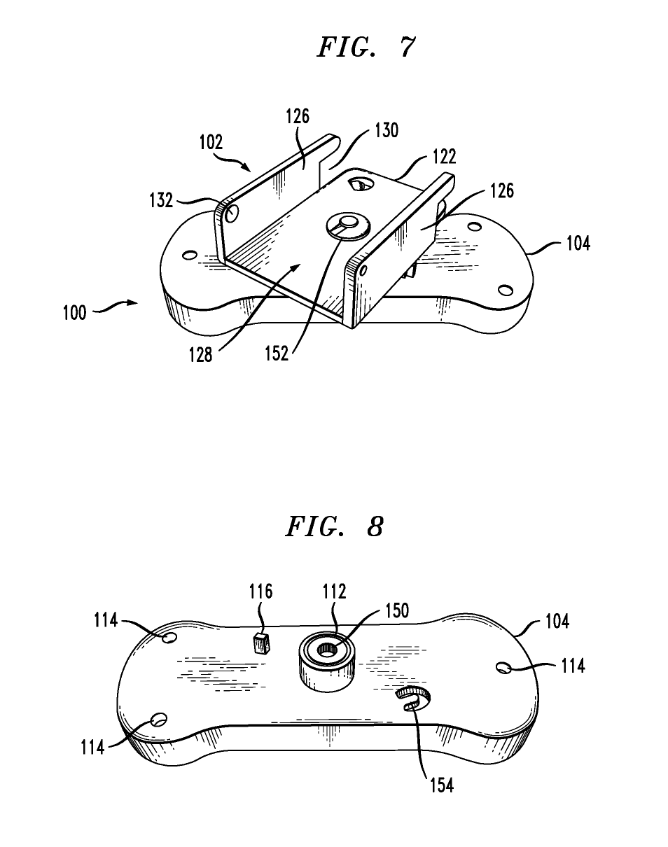

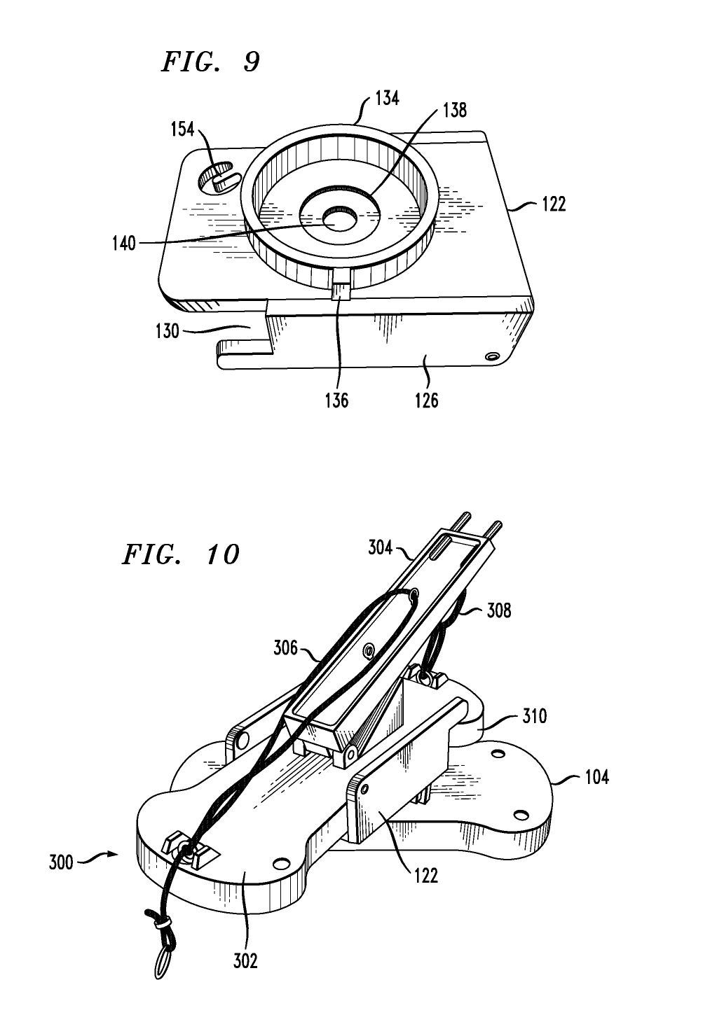

The upper base portion 102, in turn, comprises a first upper subportion 122 and a second upper subportion 124. Each of these subportions comprises different mounting features for use in mounting a decoy on the base. As shown in FIGS. 7, for example, the first upper subportion comprises two raised vertical sidewalls 126 that run substantially parallel with one another and, thereby, acting to define a channel 128. Each vertical sidewall includes a square cutout 130. The vertical sidewalls also define two small circular protrusions 132. The underside of the first upper subportion (FIG. 9) comprises an upper cylindrical feature 134, an upper stop feature 136, a circular recessed region 138, and an upper hole 140 centered within the circular recessed region. The circular recessed region preferably has substantially the same diameter as the lower cylindrical feature 112.

In contrast, the second upper subportion 124 comprises a cylindrical receptacle 142 that includes a small vertical notch 144. This second upper subportion is manually separable from the first upper subportion 122. When in place, the second upper subportion occupies the channel 128 defined by the vertical sidewalls 126 of the first upper subportion 122. The second upper subportion securely locks into place by having two wing features 146 that fit into the square cutouts 130 in each of the vertical sidewalls. In addition, the two circular protrusions 132 in the vertical sidewalls act to limit any vertical movement in the second upper subportion. The second upper subportion is attached to the cord 1110 via an eyelet 148.

In accordance with an aspect of the invention, the upper base portion 102 is pivotally mounted to the lower base portion 104. More specifically, when the base 100 is assembled, the top of the lower cylindrical feature 112 abuts the upper base portion and is disposed within the circular recessed region 138. As mentioned earlier, the lower cylindrical feature and the circular recessed region preferably have substantially the same diameter. Having the lower cylindrical feature engage the circular recessed region in this manner allows the upper portion to pivot on the lower cylindrical feature while not allowing the upper base portion to move laterally with respect to the lower base portion. When assembled, the upper cylindrical feature 134 also surrounds the lower cylindrical feature and abuts the top of the lower base portion. This provides even more stability to the upper base portion during pivoting.

It will be noted from FIGS. 6 and 8 that the lower cylindrical feature 112 defines a lower hole 150 that penetrates through the lower base portion 104. Near the top of the lower cylindrical feature, the lower hole is substantially narrower than it is near the bottom of the feature. This design allows the upper base portion to be securely fastened to the lower base portion using a push-in rivet 152 such as a Tuflok® Plastic Rivet from ITW Engineered Fasteners of Chippewa Falls, Wis., USA. The push-in rivet is inserted through the upper hole 140 in the first upper subportion 122 and into the lower hole in the lower cylindrical feature. The push-in rivet is preferably sized (e.g., ½ inch length) so that at least a portion of the flared part of the rivet lies within the larger diameter portion of the lower hole. This helps to assure that the push-in rivet remains securely in place and does not fall out.

As indicated earlier, the elastic member 106 spans between the lower base portion 104 and the upper base portion 102. The elastic member is preferably in the form of a band. It may, for example, comprise a conventional rubber band. In the illustrative base, opposite ends of the elastic member are attached to both the lower and upper base portions, respectively, by attaching to nibs 154 defined by each of the respective base portions.

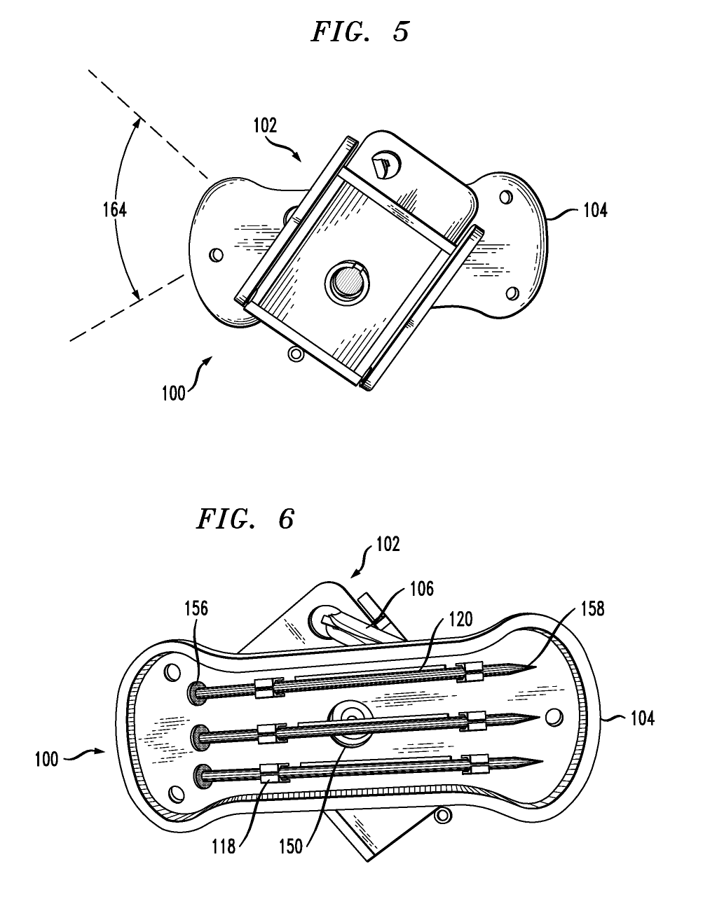

The elastic member 106 is configured to elastically bias the upper base portion 102 to pivot in a given direction in relation to the lower base portion 104. That is, the elastic member is configured so that the elastic member's natural tendency to contract when stretched provides a force to the upper base feature that drives (i.e., pulls) that feature to pivot in a given direction. When considered top-down as in, for example, FIG. 5, the upper base portion is elastically biased to pivot in a counter-clockwise direction relative to the lower base portion (as indicated on the figure). Nevertheless, this relative pivoting motion is restricted by the lower stop feature 116 and the upper stop feature 136. When the lower stop feature abuts the upper stop feature, no additional rotation in the elastically biased direction is possible. For that reason, if no external force is applied to the base, the upper portion is oriented in relation to the lower portion as shown in FIGS. 5. If an external force is applied to the upper base portion that causes that portion to pivot in a clockwise direction relative to the lower base portion, removing that external force will cause the upper base portion to pivot in a counter-clockwise direction until the lower again abuts the upper stop feature.

The anchoring spikes 114 allow the base 100 to be mounted on a surface such as the ground. As shown by FIG. 6, the anchoring spikes preferably comprise long, nail-shaped elements with a head 156 (i.e., round, flat piece) at one end and a point 158 at the other. The lengths of the anchoring spikes between the heads and the points preferably have a diameter slightly less than that of the anchoring holes 114 while the heads preferably have a diameter larger than that of the anchoring holes. This configuration allows the anchoring spikes to be easily inserted through the anchoring holes of the lower base portion 104 and then forcefully driven into the underlying ground using, for example, a hammer. Driving the anchoring spikes into the ground until the heads of the spikes meet the upper surface of the lower base portion acts to securely fasten the base to the ground.

In terms of materials, the lower and upper base portions 102, 104 preferably comprise a polymer material such as polyethylene, the mounting rod 108 preferably comprises a metallic material such as aluminum, and the anchoring spikes 114 preferably comprise a metallic material such as galvanized steel. The cord 110 preferably comprises nylon. Nevertheless, these material choices are merely illustrative and several materials can be substituted for the specific ones described herein.

The manner in which the illustrative base 100 may impart motion to a decoy will now be described for both conventional, stake-mounted, static decoys and decoys that are cord-actuated and comprise integral platforms. As described earlier, for conventional stake-mounted, static decoys the base is preferably configured with the second upper subportion 124 and mounting rod 108 in place, as shown in FIGS. 1. In this configuration, one end of the mounting rod 108 is inserted into the decoy 200 and the other is inserted into the cylindrical receptacle 142. The cylindrical receptacle is dimensioned to hold the mounting rod upright. A pin 160 on the rod engages the vertical notch 144 in the cylindrical receptacle, thereby assuring that the mounting rod pivots with upper base portion. The mounting rod is also preferably attached to an extension feature 162 that is positionable to project outward from the mounting rod. This extension feature engages the inside of the decoy and assures that the decoy will also rotate with the upper base 102.

Once so configured, the hunter (or other user of the base 100) may impart a pivoting motion to the decoy 200 by drawing the cord 110 away from the base. The cord is preferably drawn in a direction away from the base within the angle 164 shown in FIG. 5. Doing so imparts an external force on the upper base portion 102 that causes the upper base portion to pivot in a direction opposite to the elastically biased direction of the base. When this external force is relaxed, the upper base portion returns to the orientation in which the lower stop feature 116 abuts the upper stop feature 136 as a result of forces provided by the elastic member 106.

Accordingly, a hunter may anchor the base 100 at a particular location and then mount a conventional, stake-mounted, static decoy (like decoy 200) on the base as shown in FIG. 1. The hunter may then assume a hidden position somewhat removed from the base and decoy and actuate repetitive pivoting motion in the decoy using the cord 110. Doing so provides the hunter with a substantially better chance of attracting a game animal to the decoy than if the hunter were to simply use the static decoy without the motion that the base provides.

FIGS. 10, in contrast, show the illustrative base 100 in combination with a cord-actuated decoy 300 having an integral platform such as one in accordance with aspects of U.S. patent application Ser. No. 11/683,349 (cited in the Background Section and hereby incorporated by reference hereinto). Briefly, the decoy includes an integral platform 302 and an arm 304 hingedly mounted to that platform. A replica of an animal's head and other body parts (not shown) may be attached to the arm. When a user pulls on a cord 306, the arm rises forward. When the hunter releases the cord, the arm returns to an oblique reclined position in response to the pull of an elastic band 308.

Mounting this decoy 300 on the base 100 may be achieved by removing the second upper subportion 124 from the upper base portion 102 and inserting the integral platform 302 into the channel 128 created by the vertical sidewalls 126 of the first upper subportion 122. Flared portions 310 of the integral platform engage the square cutouts 130 in the vertical sidewalls causing the decoy to be securely held in place in the base.

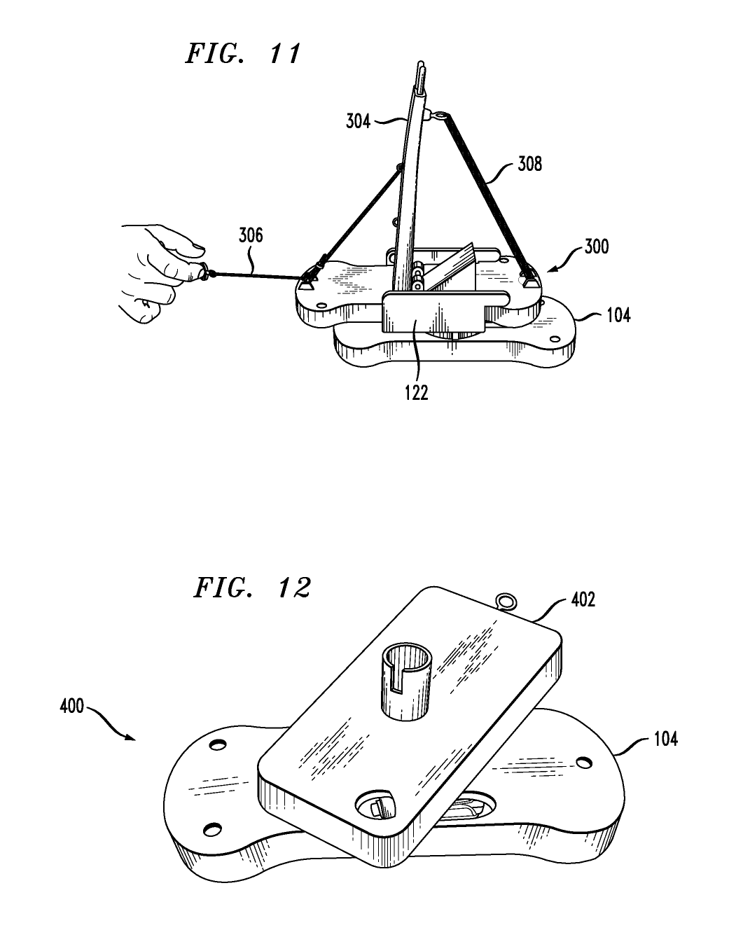

Operating the base 100 and decoy 300 is similar to that described earlier, but in the present configuration, the cord 306 is attached to the decoy rather than being attached to the base. This causes the cord to actuate two motions rather than one. In the present illustrative combination, drawing the cord away from the combination causes both the arm to rise forward in decoy and causes the base to pivot the decoy. FIG. 11 shows the base and decoy with the cord drawn so that the upper base portion 102 has pivoted and the arm 304 is standing upright. Whether these two movements occur sequentially or in sequence depends on the relative resistances of the decoy and base to these particular motions. In general, the motion having the higher resistance will tend to begin later than that with the lower resistance. For example, if the pivoting of the base has a higher resistance than the moving of the arm, the arm will tend to rise before the base begins to pivot. To some extent, the relative resistances of the two motions can be tuned by modifying the relative properties (e.g., thicknesses and/or compositions) of the elastic member 106 on the base and the elastic band 308 on the decoy.

It should again be emphasized that the above-described embodiments of the invention are intended to be illustrative only and that alternative embodiments within the scope of the appended claims will be apparent to one skilled in the art. FIG. 12, for example, shows an alternative base 400 in accordance with an additional illustrative embodiment of the invention. The alternative base 400 shares many features with the illustrative base 100 and, accordingly, these identical features are, labeled with common reference numerals. However, unlike the illustrative base 100, the alternative base 400 comprises a simplified upper base portion 402 that is designed exclusively for use with conventional, stake-mounted, static decoys. It does not include the modular features of the illustrative base 400 that allow that base to also work with cord-actuated decoys with integral platforms (e.g., decoy 300). Nevertheless, this alternative illustrative base would also fall within the scope of the invention. Moreover, it is also foreseen that a base in accordance with aspects of this invention may be used with any number of existing decoys, not necessarily only those similar to the decoys 200, 300 explicitly shown herein. One skilled in the art will recognize how to modify a decoy or how to modify the base so that the two elements can be combined.

In addition, all the features disclosed herein may be replaced by alternative features serving the same, equivalent, or similar purpose, unless expressly stated otherwise. Thus, unless expressly stated otherwise, each features disclosed is one example only of a generic series of equivalent or similar features.

What is claimed is:

1. A base for providing motion to a decoy, the base comprising:
a lower base portion;
an upper base portion pivotally attached to the lower base portion such that the upper base portion can pivot in relation to the lower base portion; and
an elastic member spanning between the lower and upper base portions and configured to elastically bias the upper base portion to pivot in a given direction in relation to the lower base portion.

2. The base of claim 1, wherein the lower base portion defines a plurality of holes.

3. The base of claim 1, wherein the lower base portion comprises a lower cylindrical feature that abuts the upper base portion.

4. The base of claim 3, wherein the upper base portion defines a circular recessed region with a diameter substantially similar to a diameter of the lower cylindrical feature.

5. The base of claim 4, wherein a portion of the lower cylindrical feature is disposed within the circular recessed region.

6. The base of claim 3, wherein the upper base portion further comprises an upper cylindrical feature that laterally surrounds the lower cylindrical feature and abuts the lower base portion.

7. The base of claim 1, further comprising a cord connected to the upper base portion.

8. The base of claim 7, wherein the upper base portion is operative to be pivoted in a direction opposite to the elastically biased direction by drawing the cord away from the base.

9. The base of claim 1, wherein the upper base portion is pivotally attached to the lower base portion at least in part by a push-in rivet.

10. The base of claim 1, wherein the lower and upper base portions each define a respective nib about which the elastic member is attached.

11. The base of claim 1, wherein the lower base portion comprises one or more attachment points adapted to secure one or more anchoring spikes to the base.

12. The base of claim 1, wherein the upper base portion is operative to be pivoted in a direction opposite to the elastically biased direction by drawing a cord attached to the decoy away from the base.

13. The base of claim 1, wherein the upper base portion comprises a cylindrical receptacle.

14. The base of claim 13, further comprising a mounting rod, wherein the cylindrical receptacle is configured to hold the mounting rod upright when the mounting rod is inserted therein.

15. The base of claim 13, wherein the mounting rod is attached to an extension feature positionable to project outward from the mounting rod.

16. The base of claim 1, wherein the upper base portion comprises two raised vertical sidewalls running substantially parallel with one another and defining a channel therebetween.

17. The base of claim 1, wherein at least one of the two raised vertical sidewalls defines a cutout in the respective vertical sidewalls.

18. The base of claim 1, wherein the upper portion comprises:
a first upper subportion, the first upper subportion comprising two raised vertical sidewalls running substantially parallel with one another and defining a channel therebetween; and
a second upper subportion disposed at least partially within the channel, the second upper subportion comprising a cylindrical receptacle;
wherein the second upper subportion is manually separable from the first upper subportion.

19. The base of claim 1, wherein the lower base portion comprises a lower stop feature, the upper base portion comprises an upper stop feature, and the pivoting of the upper base portion in relation to the lower base portion is restricted by the upper stop feature abutting the lower stop feature.

20. A method of forming a base for providing motion to a decoy, the method comprising the steps of:
receiving a lower base portion;
attaching an upper base portion to the lower base portion such that the upper base portion can pivot in relation to the lower base portion; and
spanning an elastic member between the lower and upper base portions, the elastic member configured to elastically bias the upper base portion to pivot in a given direction in relation to the lower base portion.
